(19) United States
(12) Patent Application Publication
(10) Pub. No.: US 2006/0016341 A1
(43) Pub. Date: Jan. 26, 2006

(54) Kettle having spout liner and spout jacket

(76) Inventors: James Wilson, Norwood, MA (US); William J. Palm, Newtonville, MA (US); Gregg Flender, Bedford, MA (US); John Costello, Wellesley, MA (US); Richard G. Groth, Elgin, IL (US)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 10/895,028

(22) Filed: Jul. 20, 2004

(51) Int. Cl. A23L 1/00

(52) U.S. Cl. 99/275

(57) ABSTRACT

A kettle for heating water or other liquid may have a container with a top portion made separately from a lower portion and permanently secured thereto. The top portion may have a fill opening that may be registered with an opening in the lower portion and receive a lid to cover the fill opening. A spout liner may extend from the container and be at least partially surrounded by a spout jacket. The spout liner may have a rolled or flanged portion that forms a seal between the spout liner and the spout jacket or that engages with the spout jacket. A handle may be integrally formed with the spout jacket and/or the top portion, e.g., molded together in a unitary form.

### RELATED APPLICATIONS

This application is related to co-pending application Ser. No. ______, filed Jul. 20, 2004, entitled KETTLE HAVING OFFSET OPENING AND RECESSED LID, bearing Attorney Docket No. W0543.70076US00, and application Ser. No. ______, filed Jul. 20, 2004, entitled KETTLE HAVING MOVABLE SPOUT LID AND ACTUATOR, bearing Attorney Docket No. W0543.70081US00. These applications are hereby incorporated by reference in their entirety.

### BACKGROUND OF INVENTION

1. Field of Invention

This invention relates to a kettle for heating liquid, such as water.

2. Description of Related Art

Tea kettles are widely used for heating liquid, such as water, on a stovetop or other heat source. Some tea kettles have a built-in heat source, such as an electric resistance heating element, and need not be heated by an external heat source. Regardless of the heating mechanism, water or other liquid must be placed in the kettle for heating. In some kettles, water is introduced into the kettle through a spout that is also used to dispense the water from the kettle. Other kettles have an opening separate from the spout that is used for filling the kettle. Such openings are typically positioned in the top of the kettle and are covered by a lid. Often, the opening and corresponding lid are located under a handle for holding the kettle.

### SUMMARY OF INVENTION

In one aspect of the invention, a kettle for heating a liquid includes a container arranged to hold an amount of liquid. The container may have a substantially flat bottom and a spout liner extending from an upper section of the container. A spout jacket may be disposed around at least a portion of the spout liner and connected to the container. A handle may be connected to the container and constructed and arranged to be gripped by a human hand and allow carrying of the container while holding the amount of liquid. The spout liner may have a rolled or flanged portion at a distal or upper end. The rolled or flanged portion may in some embodiments provide a seal between the spout liner and the spout jacket. The rolled or flanged portion may also provide a mechanical connection between the spout liner and the spout jacket. Such a mechanical connection may help keep the spout liner and the spout jacket connected together, e.g., when the spout jacket is integrally formed with a carrying handle for the kettle. In some embodiments, the rolled or flanged portion may provide a lip or other feature to aid in pouring liquid from the container, e.g., to help prevent dripping from the spout when pouring.

In another aspect of the invention, a kettle may include a container that has a lower portion with a substantially flat bottom and a spout liner defining a spout opening and extending from an upper section of the lower portion. The upper section may have an opening separate from the spout opening. A top portion may be connected to the upper section of the lower portion and cover at least a portion of the opening in the upper section. The top portion may also have a fill opening in registration with the opening in the upper section that is arranged to receive a lid to cover the fill opening. A spout jacket may disposed around at least a portion of the spout liner and connected to the container. A handle may be connected to the container and constructed and arranged to be gripped by a human hand and allow carrying of the container.

In one aspect of the invention, the lower portion and the top portion may be made separately from each other and permanently attached together to form the container. In another aspect, the spout jacket and/or the handle and/or the top portion may be integrally formed. For example, the spout jacket and the handle may be molded in a unitary fashion from a plastic material. Alternately, the spout jacket, handle and top portion may be molded in a unitary fashion from a plastic material.

In another aspect of the invention, the container may have a metallic lower portion, including the substantially flat bottom, and a plastic top portion, with the plastic top portion being permanently secured to the metallic lower portion.

Various other aspects of the invention will be apparent and/or obvious from the following detailed description. It should be noted that when incorporated in a particular embodiment, various aspects of the invention may be combined and used together, or may be used separately from other aspects of the invention.

### BRIEF DESCRIPTION OF THE DRAWINGS

Various aspects of the invention are described below with reference to the following drawings, in which like numerals reference like elements, and wherein:

FIG. 1 is a perspective view of an illustrative embodiment incorporating various aspects of the invention;

FIG. 2 is a side view of the FIG. 1 embodiment;

FIG. 3 is a top view of the FIG. 1 embodiment;

FIG. 4 is a top view of the lower portion of the kettle container with the top portion, spout jacket and handle removed;

FIG. 5 is a side view of the lower portion of the kettle container with the top portion, spout jacket and handle removed;

FIG. 6 is a top view of the top portion;

FIG. 7 is a cross-sectional view along the line 7-7 shown in FIG. 3;

FIG. 8 is a close up view of the cross-section of the spout in FIG. 7;

FIG. 9 is a cross-sectional view of connection arrangement between the top portion and the lower portion along the line 9-9 in FIG. 3; and

FIG. 10 is a cross-sectional view along the line 10-10 in FIG. 9.

### DETAILED DESCRIPTION

Aspects of the invention are described below with reference to illustrative embodiments. However, it should be understood that aspects of the invention are not limited to those embodiments described below, but instead may be used in any suitable arrangement. For example, a kettle having an approximately cylindrical shape and rounded top is shown in the drawings, but a kettle in accordance with various aspects of the invention may have any size, shape or other configuration.

In one aspect of the invention, a kettle may have container with a spout liner extending from an upper section of the container. A spout jacket may be at least partially disposed around at least a portion of the spout liner and connected to the container. The spout liner may have a rolled or flanged portion at a distal or upper end which may provide a seal between the spout liner and the spout jacket, e.g., so water being poured from the kettle does not enter a space between the spout jacket and the liner. The rolled or flanged portion may also provide an improved or more robust mechanical connection between the spout liner and the spout jacket, such as when a carrying handle for the kettle is directly attached to the spout jacket. In such an arrangement, a large portion, if not all, of the weight of the kettle may be borne by the spout liner and therefore by the connection between the spout liner and the spout jacket. In other embodiments, the rolled or flanged portion may provide a lip or other feature to aid in pouring liquid from the container, e.g , to help prevent dripping from the spout when pouring

In another aspect of the invention, a kettle may include a container with a lower portion and a top portion that are made separately from each other and later permanently connected together to form the container. For example, the lower portion may have a substantially flat bottom and a spout liner extending from an upper section of the lower portion. The upper section may also have an opening separate from the spout opening, e.g., through which the container may be filled with water. The top portion may be connected to the upper section of the lower portion and cover at least a portion of the opening in the upper section. The top portion may also have a fill opening in registration with the opening and receive a lid to cover the fill opening. A spout jacket may be at least partially disposed around the spout liner, and a handle may be connected to the container to allow carrying of the container.

By enabling the container to be made in two parts, the kettle may include different materials used for the lower and top portions. For example, the lower portion may be made of a high conductivity material, such as a metal or combination of metals, and the top portion may be made of a lower conductivity material, such as a plastic. Such an arrangement may make the kettle lighter, since the top portion may be made of a lighter and/or lower strength material. Alternately, the top portion may be made to be more thermally insulating and/or less thermally conductive than the bottom portion, e.g., to help retain heat in the kettle. The spout liner may be made of the same material as the lower portion, and provide a relatively robust structure on which to mount the handle for the kettle. That is, the handle may be mechanically connected to the spout liner so that the weight of the kettle is transferred from the spout liner to the handle.

In one aspect of the invention, the spout jacket, the handle and/or the top portion may be integrally formed. For example, the spout jacket and the handle may be molded in a unitary fashion from a plastic material. This unitary structure may be secured to the spout liner. Alternately, the spout jacket, handle and top portion may be molded in a unitary fashion from a plastic material.

FIGS. 1-9 show an illustrative embodiment of a kettle that incorporates several aspects of the invention. As can be seen in FIG. 1, this illustrative embodiment of a tea kettle 1 includes a container 2 that may include any suitable material(s), such as one that is highly thermally conductive and has a relatively high melting point, such as stainless steel, copper, aluminum or other metals. The container 2 may have any suitable size or shape and may be made from one unitary piece, or as an assembly of two or more pieces. In this illustrative embodiment, the container 2 has an approximately cylindrical shape with a rounded top portion 3 and a lower portion 4 with a substantially flat bottom. The kettle also includes a handle 5 by which the kettle 1. A spout lid 6 may cover a spout opening in a spout jacket 9 and be selectively opened and/or closed by a trigger 10 and associated lid control mechanism. The container 2 may also include a fill opening 7, having a removable a lid 8, to fill the container 2 with liquid. Alternately, the fill opening 7 may not be provided, and the container 2 may be filled through the spout opening.

In accordance with one aspect of the invention, the top portion 3 of the container 2 may be made of a different material or combination of materials than a lower portion 4 of the container 2. For example, the top portion 3 may be made of a suitable plastic or other material having a relatively low thermal conductivity. In contrast, the lower portion 4 of the container 2 may be made of a material having a higher thermal conductivity, such as a metal. The lower portion 4 of the container 2 may have bottom made of a highly conductive material, such as copper or aluminum, and have an upper section above the bottom that is made of a lower conductivity material, such as stainless steel. In such an arrangement, the thermal conductivity of the lower portion 4 of the container 2 is considered to be an average of the conductivities of the various constituent parts. The higher thermal conductivity material in the lower portion 4 of the container may aid in rapidly heating the water or other liquid in the container 2. In contrast, the lower thermal conductivity material at the top portion 3 may help to thermally insulate the liquid and help reduce heat loss through the top portion of the container 2. In addition, the lower thermal conductivity material at the top portion 3 may help reduce the risk that a user's hand is burned through inadvertent or intentional contact with the top portion 3.

The top portion 3, such as one made of a nylon or other suitable plastic, may be permanently secured to the lower portion 4. As used herein, “permanently” secured refers to a condition wherein the top portion 3 and the lower portion 4 are connected together in such a way that the top and lower portions are not intended to be disconnected from each other during normal use, but does not mean that the top and lower portions can never be disconnected. Such connection may be made by screws, glue, rivets or other fasteners. Of course, in other aspects of the invention, it will be understood that the lower portion 4 and the top portion of the container may be made of a single type of material, such as stainless steel, and may be made as a single unitary part.

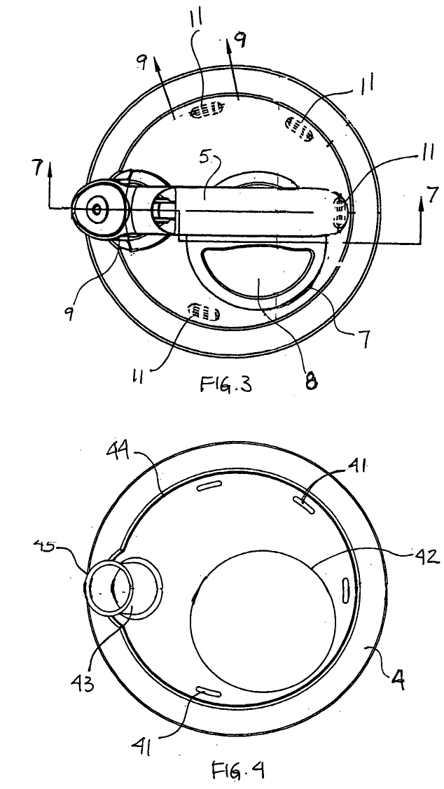

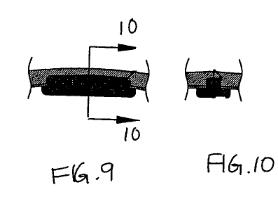

In one aspect of the invention, the top portion 3 may be secured to the lower portion 4 using fasteners applied from the interior of the container 2. FIG. 3 shows a top view of the kettle 1 indicating attachment points (in dashed line) between the top and lower portions 3 and 4 in an illustrative embodiment. In this illustrative embodiment, the top portion 3 is connected to the upper section of the lower portion 4 at rivet-type connections 11. FIGS. 9 and 10 show cross-sectional views of an illustrative rivet-type connection 11, with FIG. 9 showing a view along the line 9-9 in FIG. 3 and FIG. 10 showing a view along the line 10-10 in FIG. 9. The connections 11 may be formed by sonic welding, other thermal means, screws, conventional rivets, glue or any other suitable fastener. For example, the connections 11 may each be formed by a plug of plastic material that is inserted from inside into slots 41 in the lower portion 4 (see FIG. 4) and is sonically welded or otherwise attached to the top portion 3. The connections 11 may be robust enough to support the weight of the kettle, e.g., when the top portion 3 is formed integrally with the handle 5, and may be applied from within the container 2 before the bottom is secured to the upper section of the lower portion 4. The connections 11 may also form a liquid-tight seal between the top portion 3 and the lower portion 4, e.g., by tightly engaging the portions to prevent leaks at the junction between the top portion 3 and the lower portion 4. A liquid-tight seal may also be formed or enhanced by a seal and/or sealant positioned between the top and lower portions 3 and 4.

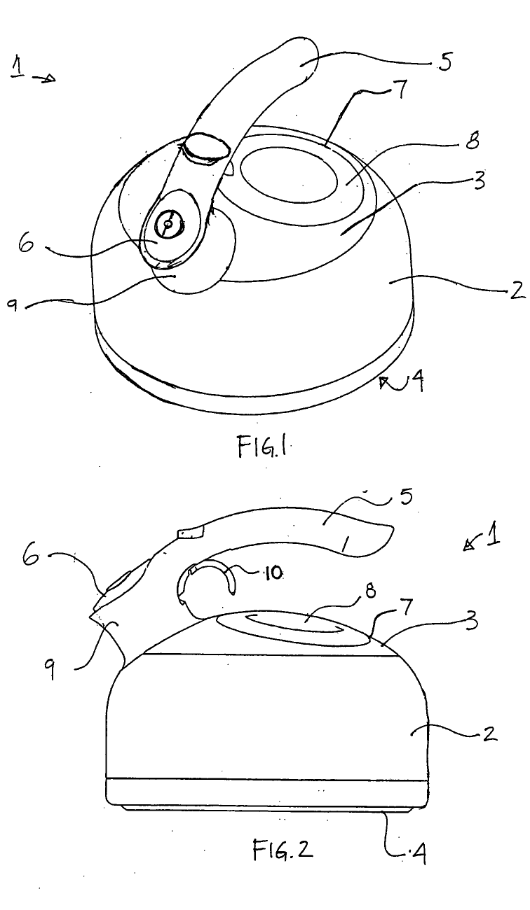

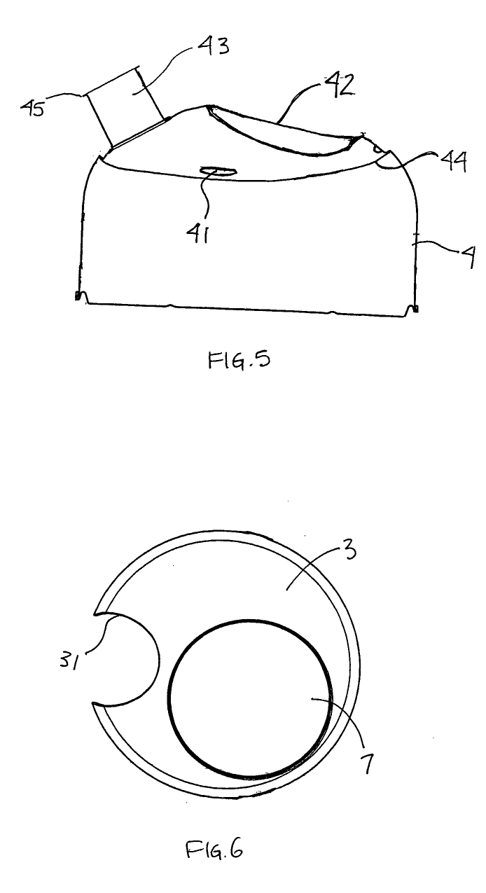

FIGS. 4 and 5 show the lower portion 4 of the kettle 1 with the top portion 3 and the spout jacket 9 removed. In accordance with one aspect of the invention, the lower portion 4 has an opening 42 separate from a spout opening defined by a spout liner 43. The opening 42 may be registered with the fill opening 7 in the top portion 3 when the top portion 3 is secured to the lower portion 4. Thus, water, for example, may pass through the fill opening 7 and the opening 42 to fill the kettle 1. The opening 42 may be very close in size to the fill opening 7, or may be substantially larger, e.g., approximately the size of the outer periphery of the top portion 3. A recessed or stepped section 44 of the lower portion 4 may be provided to receive the top portion 3 so that the top and lower portions 3 and 4 form a smooth contour at their junction, e.g., as shown in FIG. 2. Of course, such a recessed or stepped portion 44 is optional.

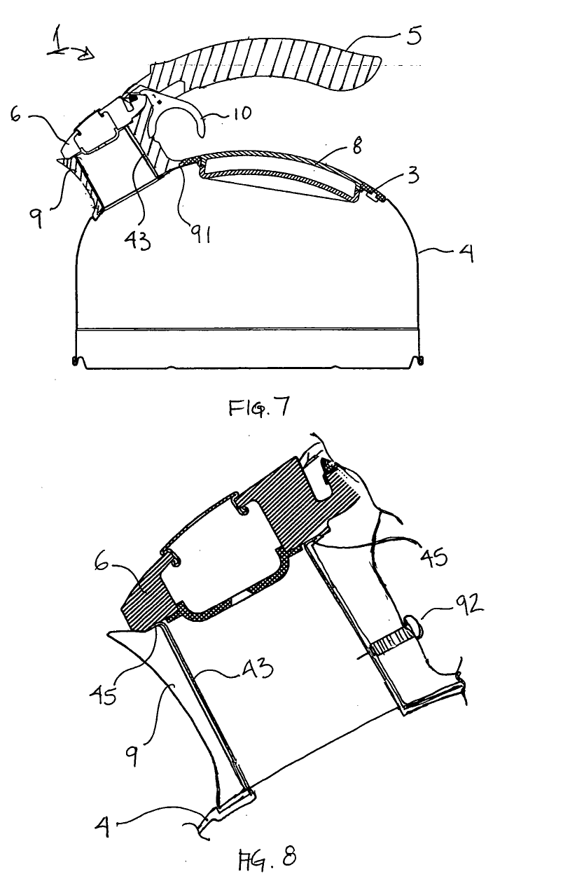

FIG. 6 shows the top portion 3 separate from the lower portion 4. In this illustrative embodiment, the top portion 3 has a fill opening 7 to receive the lid 8 and a cutout portion 31 to receive the spout jacket 9. Thus, the top portion 3 may be first secured to the lower portion 4, and the spout jacket 9 attached at the spout liner 43 to at least partially overlap the top portion 3 near the cutout portion 31, e.g., to help keep the top portion 3 securely attached to the lower portion 4. For example, FIG. 7 shows a cross sectional view along the line 7-7 in FIG. 3. In this illustrative embodiment, the spout jacket 9 is shown partially overlapping the cutout portion 31 of the top portion 3 (at reference 91), thereby aiding in keeping the top portion 3 secured to the lower portion 4. Alternately, the top portion 3 may be secured to the lower portion 4 after the spout jacket 9 is in place, e.g., to help keep the spout jacket 9 securely fastened to the container 2.

In another aspect of the invention, the spout liner 43 may be rolled or flanged at a distal end with the spout jacket 9 at least partially disposed around the spout liner 43. FIGS. 4 and 5 show the rolled or flanged end 45 of the spout liner 43. As discussed above, the rolled or flanged end 45 may form a seal with the spout jacket 9, provide a mechanical connection with the jacket 9 and/or provide improved pouring characteristics. FIG. 8 shows a close up view of the spout jacket 9 and how the rolled or flanged end 45 engages with the upper end of the spout jacket 9 to form a seal between the spout jacket 9 and the spout liner 43. This seal may help prevent liquid from entering the space between the spout jacket 9 and the spout liner 43, help provide mechanical support to the connection between the spout jacket 9 and the spout liner 43 and/or aid in providing drip-free pouring from the kettle 1. The rolled or flanged end 45 of the spout liner 43 may be formed after the spout jacket 9 has been positioned on the spout liner 43, e.g., to help engage the spout jacket and spout liner more securely, or may be performed before mounting the spout jacket 9. Although the flanged or rolled end on the spout liner may provide suitable mechanical support between the spout and the spout liner (even when the handle is connected to the spout as in this embodiment), the spout jacket may be further engaged with the spout liner 43 by other arrangements, such as a screw 92 or other fastener.

In this illustrative embodiment, the spout jacket 9 is formed as a sleeve that is positioned over the entire length of the spout liner 43. However, the spout jacket 9 need not be positioned around the entire length of the spout liner 43, e.g., the spout liner may extend above the spout jacket 9, or may be exposed near its connection with the upper portion 4. Also, although in this illustrative embodiment, the spout jacket 9 extends completely around the spout liner 43, the spout jacket 9 may only extend around a portion of the surface of the spout liner 43. For example, the spout jacket 9 may only extend around a rear portion of the spout liner 43, leaving the portion of the spout liner 43 opposite the trigger 10 exposed. In addition, although in the illustrative embodiments the spout jacket 9 is made as a single piece, the spout jacket 9 may be made of two or more pieces, e.g., in a clam shell arrangement. Although the spout liner 43 is shown as having a circular cross section, the spout liner 43 may have any suitable cross-section, such as square, rectangular, irregular, oval, etc. The rolled or flanged end of the spout liner 43 likewise need not extend around the entire circumference of the spout liner 43. Instead, only one or more partial sections of the end of the spout liner 43 need be rolled or flanged.

In another aspect of the invention, the spout jacket 9 may be integrally formed with the top portion 3 and/or the handle 5. That is, the spout jacket 9 and the handle 5 or the spout jacket 9 and the top portion 3 may formed as a single unitary piece. Thus, the spout jacket 9 and/or the handle 5 and/or the top portion 3 may be molded from a suitable plastic material to form a single piece, or may otherwise be attached together. In this illustrative embodiment, the spout jacket 9 and the handle 5 are molded as a single unitary piece. This single unitary piece may be fastened to the top portion 3 or the lower portion 4 as discussed above.

It should be appreciated, however, that aspects of the invention discussed above are not required to be used with all other aspects of the invention. Thus, for example, the rolled or flanged end on the spout liner need not be used in every embodiment of the invention. Similarly, the spout jacket 9 may be made separate from the handle 5 or top portion 3 and may be secured to the container 2 or formed in other ways. For example, the spout jacket 9 may extend from a sidewall of the container 2 and be spaced from the top portion 3, if present. Likewise, the handle 5 may be attached to other portions of the container 2 and may be separate from the spout jacket 9. Also, the handle 5 need not be fixed in place, but instead may, for example, be pivotally mounted to the container 2 so that the handle 5 may fold down, e.g., for storage. The handle 5 may be folded up to extend over the top of the container for use in carrying the kettle. The kettle 1 may also include a lid 6 to cover the discharge area of the spout jacket 9 and may optionally include a whistle or other element to indicate that the water or other liquid has been suitably heated. The lid 6 may be associated with a trigger 10 (see FIG. 2) or other suitable mechanism to allow a user to open and/or close the cover 6 as is known in the art. The trigger 10 or other control mechanism for the cover 6 may be arranged in any suitable way.

In another aspect of the invention, a lid that covers the fill opening in the top portion of the container may be received into the opening so that the upper end of the lid is flush with the top portion of the container. For example, as can be seen in the cross-sectional view in FIG. 7, an upper end of the lid 8 is flush with the top surface 3 so that the lid 8 matches the contour of the top portion 3. Although the lid 8 may have any suitable arrangement, in this illustrative embodiment, the lid has a bowl shape with a circular lip extending around the periphery of the upper end of the bowl recess. It should be understood that the bowl-shape shown in the figures is only one such bowl-shape with a circular cross-section. Other bowl-shapes are possible, such as those having a rectangular, oval, irregular or other suitable cross-section. What is meant by a bowl-shape is that the lid has a recessed center portion with raised sides. Such an arrangement may allow for easier removal of the lid 8 without the need to grip a handle between fingers and thumb. Also, the recessed nature of the lid 8 may allow for easier operation of the trigger 10.

Having described particular embodiments of the invention in detail, various modifications and improvements will readily occur to those skilled in the art. Such modifications and improvements are intended to be part of this disclosure and within the spirit and scope of the invention. Accordingly, the foregoing description is by way of example only and the invention is defined by the following claims and their equivalents.

1. A kettle for heating a liquid, comprising:
a container arranged to hold an amount of liquid, the container having a substantially flat bottom and a spout liner extending from an upper section of the container;
a spout jacket disposed around at least a portion of the spout liner and connected to the container; and
a handle connected to the container and constructed and arranged to be gripped by a human hand and allow carrying of the container while holding the amount of liquid;
wherein the spout liner has a rolled or flanged portion at an upper end.

2. The kettle of claim 1, wherein the rolled or flanged portion of the spout liner creates a seal between the spout liner and the spout jacket.

3. The kettle of claim 1, wherein the rolled or flanged portion of the spout liner engages with a portion of the spout jacket.

4. The kettle of claim 1, wherein the spout jacket and the handle are integrally formed.

5. The kettle of claim 1, wherein the container comprises a lower portion and a top portion that are made separately from each other and permanently attached together.

6. The kettle of claim 1, wherein the container has a metallic lower portion, including the substantially flat bottom, and a plastic top portion, the plastic top portion being permanently secured to the metallic lower portion.

7. The kettle of claim 6, wherein the top portion has a fill opening, the kettle further comprising a lid that is constructed and arranged to cover the fill opening.

8. The kettle of claim 7, wherein the lid is constructed and arranged to be received into the fill opening so that an upper end of the lid lies flush with the top portion.

9. The kettle of claim 1, wherein the container has a lower portion, including the substantially flat bottom, that has a first thermal conductivity, and a top portion that is permanently secured to the lower portion and has a second thermal conductivity that is lower than the first thermal conductivity.

10. The kettle of claim 1, wherein the container comprises:
a lower portion with the substantially flat bottom and the spout liner extends from an upper section of the lower portion, the upper section having an opening separate from the spout opening, and
a top portion connected to the upper section of the lower portion and covering at least a portion of the opening in the upper section, the top portion having a fill opening in registration with the opening in the upper section, the fill opening arranged to receive a lid that covers the fill opening.

11. The kettle of claim 10, wherein the top portion is permanently secured to the lower portion.

12. A kettle for heating a liquid, comprising:
a container arranged to hold an amount of liquid, the container having:
a lower portion with a substantially flat bottom and a spout liner defining a spout opening and extending from an upper section of the lower portion, the upper section having an opening separate from the spout opening, and
top portion connected to the upper section of the lower portion and covering at least a portion of the opening in the upper section, the top portion having a fill opening in registration with the opening in the upper section, the fill opening arranged to receive a lid that covers the fill opening;
a spout jacket disposed around at least a portion of the spout liner and connected to the container; and
a handle connected to the container and constructed and arranged to be gripped by a human hand and allow carrying of the container while holding the amount of liquid.

13. The kettle of claim 12, wherein the spout liner has a rolled or flanged portion that creates a seal between the spout liner and the spout jacket.

14. The kettle of claim 12, wherein the rolled or flanged portion of the spout liner engages with a portion of the spout jacket.

15. The kettle of claim 12, wherein the spout jacket and the handle are integrally formed.

16. The kettle of claim 12, wherein the lower portion and the top portion are made separately from each other and permanently attached together to form the container.

17. The kettle of claim 16, further comprising a lid that is constructed and arranged to cover the fill opening.

18. The kettle of claim 17, wherein the lid is constructed and arranged to be received into the fill opening so that an upper end of the lid lies flush with the top portion.

19. The kettle of claim 12, wherein the container has a metallic lower portion, including the substantially flat bottom, and a plastic top portion, the plastic top portion being permanently secured to the metallic lower portion.

20. A kettle for heating a liquid, comprising:
a container arranged to hold an amount of liquid, the container having:
a lower portion with a substantially flat bottom and a spout liner defining a spout opening and extending from an upper section of the lower portion, the upper section having an opening separate from the spout opening, and
a top portion connected to the upper section of the lower portion and covering at least a portion of the opening in the upper section;
a spout jacket disposed around at least a portion of the spout liner and connected to the container; and
a handle integrally formed with the spout jacket and constructed and arranged to be gripped by a human hand and allow carrying of the container while holding the amount of liquid.

21. The kettle of claim 20, wherein the spout liner has a rolled or flanged portion at a distal end of the spout liner.

22. The kettle of claim 20, wherein the spout jacket, the handle and the top portion are integrally formed.

23. The kettle of claim 20, wherein the lower portion and the top portion are made separately from each other and permanently attached together to form the container.

24. The kettle of claim 23, wherein the top portion has a fill opening in registration with the opening in the upper section, the fill opening being arranged to receive a lid that covers the fill opening.

25. The kettle of claim 20, wherein the lid is constructed and arranged to be received into the fill opening so that an upper end of the lid lies flush with the top portion.

26. The kettle of claim 20, wherein the container has a metallic lower portion, including the substantially flat bottom, and a plastic top portion, the plastic top portion being permanently secured to the metallic lower portion.

27. The kettle of claim 20, wherein the spout jacket, the handle and top portion are molded as a single unitary piece of plastic.

28. The kettle of claim 20, wherein the spout jacket and the handle are molded as a single unitary piece of plastic.

29. The kettle of claim 20, wherein the handle is cantilevered and extends over the top portion of the container.

30. The kettle of claim 20, wherein the container is constructed and arranged to be heated by an external heat source.
